(19) United States
(12) Patent Application Publication
(10) Pub. No.: US 2023/0047059 A1
(43) Pub. Date: Feb. 16, 2023

(54) CHEMICAL MODIFICATION PROCESS FOR A POLYMER COMPONENT

(71) Applicant: COMMISSARIAT À L'ÉNERGIE ATOMIQUE ET AUX ÉNERGIES AL TERNATIVES, Paris (FR)

(72) Inventors: Pierre Piluso, Grenoble (FR); Aurélien Auger, Grenoble (FR); Olivier Blanchot, Grenoble (FR); Jérôme Delmas, Grenoble (FR); Olivier Poncelet, Grenoble (FR); Isabelle Rougeaux, Grenoble (FR)

(21) Appl. No.: 17/904,765

(22) PCT Filed: Feb. 17, 2021
(86) PCT No.: PCT/FR2021/050272

§ 371 Date: Aug. 22, 2022

(30) Foreign Application Priority Data
Feb. 26, 2020 (FR) 2001881

(51) Int. Cl. C08J 7/16

(52) U.S. Cl. CPC C08J 7/16; C08J 2377/02

(57) ABSTRACT

A chemical modification process for a polymer component comprising at least one polymer comprising, as reactive groups, amine groups and/or hydroxyl groups, the process comprising a step of covalent reaction between some or all of the reactive groups and at least one functional compound comprising at least one group able to react in a covalent manner with said reactive groups, the functional compound(s) being selected from epoxide compounds, anhydride compounds, acyl halide compounds, silyl ether compounds and mixtures thereof, characterised in that the covalent reaction step is carried out in the presence of at least one supercritical fluid.

### TECHNICAL FIELD

The present invention relates to a process for chemically modifying a polymer component by covalent reaction thereof with at least one chemical compound in a medium making a chemical modification possible both at the surface and at the core of the polymer component, i.e. in other words in the entire volume of the component.

According to the nature of the chemical compound(s) selected, the process of the invention may confer to the polymer component a targeted property not inherent to the component before chemical modification or may make it possible to improve a targeted property of the component, the targeted properties that may be, in a non-exhaustive manner, hydrophilic, hydrophobic, oleophilic, oleophobic, antibacterial, anti-counterfeit, anti-icing, anti-scratch, flame retardant, electric charge dissipative, cleanability, anti-ageing, aesthetic design (such as colouring, shine), mechanical (such as friction, sliding, impact resistance, abrasion resistance), electrical (such as electrical shielding, electrical conductivity, doping), adhesiveness or non-adhesiveness properties. Conventionally, the properties of a polymer component may be modified or improved in various manners, such as for example:
the addition of one or more organic or inorganic loads to form a composite material, with however the possibility that the presence of loads has a negative effect on the properties of the polymer that it is not desired to modify; or
the impregnation of the polymer by one or more chemical agents making it possible to confer or improve the targeted property with however the following drawbacks:
the impregnation only results in a surface treatment and does not make it possible to reach the component in depth, the targeted property thus only being located on the surface of the component;
the impregnation does not make strong attachment of the chemical agents possible, the targeted property conferred by this or these agents not having a satisfactory resistance over time.

In view of the foregoing, the authors of the present invention have proposed to develop a process for modifying a polymer component that does not have the limitations of the processes mentioned below.

### DESCRIPTION OF THE INVENTION

Thus, the invention relates to a chemical modification process for a polymer component comprising at least one polymer comprising, as reactive groups, amine groups and/or hydroxyl groups, said process comprising a step of covalent reaction between some or all of the reactive groups and at least one functional compound, also referred to as first compound, comprising at least one group able to react in a covalent manner with said reactive groups, the functional compound(s) being selected from epoxide compounds, anhydride compounds, acyl halide compounds, silyl ether compounds and mixtures thereof, characterised in that the covalent reaction step is carried out in the presence of at least one supercritical fluid.

By polymer component, it is specified, in the context of the invention, that it is, conventionally, a component made of a material comprising at least one polymer comprising, as reactive groups, amine groups and/or hydroxyl groups, said polymer(s) being formed of the component, for example, by a forming technique, such as the 3D printing technique or the extrusion/injection technique, the process of the invention that may thus belong in the cycle for manufacturing a component at the post-process stage (that is to say at the stage for finishing the component after its forming).

By covalent reaction, it is specified that it is a reaction for the formation of covalent bonds, this reaction occurring between the reactive groups of the polymer or polymers of the polymer component and the groups of the functional compound(s) able to react in a covalent manner with said reactive groups, whereby the covalent bonds result between the polymer or the polymers and the functional compound(s), the latter being present in the form of residues, that is to say what remains therefrom after covalent reaction of the reactive groups of the functional compound(s) with the reactive groups of the polymer(s) of the polymer component.

Thanks to the use of at least one supercritical fluid to implement this reaction, the following advantages have been observed:
the possibility of carrying the functional compound(s) in the depth of the polymer component and thus of making a chemical modification thereof possible both on the surface and in depth and therefore in the entire component;
a high solvating power, which makes it possible to confer to the reaction step a much faster reaction kinetics in relation to a similar reaction, which would be conducted in a non-supercritical medium;
the possibility of carrying out said modification without using volatile organic solvent the elimination of which after reaction would be energetically and temporally costly and traces of which would be likely to be present in the treated components;
the possibility of carrying out said modification by limiting the amount of reactive(s), if applicable, of catalyst(s) used as well as the residual amount of reactive(s), if applicable, of catalyst(s) in the polymer components comparatively with conventional impregnation processes.

Moreover, the process of the invention may have the following advantages:
an easily industrialisable process including a small number of steps, generally not requiring large amounts of products (which is an advantage of using a supercritical fluid in relation to immersion techniques in a liquid solvent) and making the simultaneous treatment of a plurality of components possible;
no prior preparation of the surface of the components to be treated;
the possibility of treating all of the complex reliefs of the components, if applicable.

By supercritical fluid, it is understood a fluid brought to a pressure and a temperature beyond its critical point, corresponding to the temperature and pressure pair (respectively T_{C} and P_{C}), for which the liquid phase and the gas phase have the same density and beyond which the fluid is in its supercritical range. In supercritical conditions, the fluid has a greatly increased dissolving power in relation to the same fluid in non-supercritical conditions and therefore facilitates the solubilisation of the functional compound(s). It is understood that the supercritical fluid used is capable of solubilising the functional compound(s) used.

The supercritical fluid advantageously may be supercritical CO₂, particularly due to its low critical temperature (31° C.), which makes it possible to implement the reaction at low temperature without risk of degradation of the functional compound(s). More precisely, supercritical CO₂ is obtained by heating carbon dioxide beyond its critical temperature (31° C.) and by compressing it above its critical pressure (73 bars). What is more, supercritical CO₂ is non-flammable, non-toxic, relatively inexpensive and does not require reprocessing at the end of the process, comparatively with processes involving the exclusive use of organic solvent, which also makes it a “green” solvent relevant from an industrial point of view. Finally, supercritical CO₂ has a good solvating power (adaptable depending on the pressure and temperature conditions used), a low viscosity and a high diffusivity. Finally, its gaseous nature in ambient pressure and temperature conditions renders, at the end of the reaction and once the CO₂ has been brought back to a non-supercritical state, the steps of separating the component thus modified and the reaction medium (comprising, for example, compounds that have not reacted) and as well as the reuse of CO₂, easy to carry out. Moreover, supercritical CO₂ is capable of being able to diffuse in depth of the polymer component and contribute to its plasticization, which may facilitate the transport of reagents and, if applicable, catalysts in the polymer component and therefore the covalent reaction step. All these aforementioned conditions contribute to making supercritical CO₂ an excellent choice of solvent to successfully complete the reaction step of the process in accordance with the invention.

As mentioned above, the process of the invention comprises a step of covalent reaction between some or all of said reactive groups (amines and/or hydroxyls) of the polymer(s) of the polymer component and at least one functional compound, also referred to as first compound, comprising at least one group able to react in a covalent manner with said reactive groups, the functional compound(s) being selected from epoxide compounds, anhydride compounds, acyl halide compounds, silyl ether compounds and mixtures thereof, characterised in that the covalent reaction step is carried out in the presence of at least one supercritical fluid.

The polymer component intended to be treated in accordance with the process of the invention is a component comprising (or even exclusively consisting of) at least one polymer comprising, as reactive groups, amine groups and/or hydroxyl groups, which are likely to react with at least one group of the functional compound(s) to form covalent bonds.

In particular, the polymer component intended to be treated in accordance with the process of the invention may be a component comprising (or even exclusively consisting of) one or more polyamides and, even more specifically, the polymer component may be a polyamide-12 component (that can be symbolised by PA-12) and, more specifically, a porous or partially porous polyamide-12 and, even more specifically, a polyamide-12 having a density less than or equal to 960 kg/m³, for example, ranging from 650 kg/m³ to 960 kg/m³, preferably, less than or equal to 900 kg/m³, for example ranging from 700 kg/m³ to 900 kg/m³.

The functional compound(s) are, advantageously, non-polymer compounds, that is to say that they are not polymers, that is to say compounds comprising a sequence of repetitive unit(s), which makes it possible for them to access more easily the core of the polymer component and react in a covalent manner with the reactive groups located at the core of the polymer component.

More specifically, the functional compound(s) used in the reaction step comprising at least one group able to react in a covalent manner with said reactive groups, are selected from epoxide compounds, anhydride compounds, acyl halide compounds, silyl ether compounds and mixtures thereof.

In other words, the functional compound(s) used in the reaction step comprise at least one group able to react in a covalent manner with said reactive groups, this or these group(s) able to react in a covalent manner with said reactive groups being selected from:
the epoxide groups (in which case the functional compound(s) are qualified as epoxide compounds);
the anhydride groups (in which case the functional compound(s) are qualified as anhydride compounds);
the acyl halide groups (in which case the functional compound(s) are qualified as acyl halide compounds);
the silyl ether groups (in which case the functional compound(s) are qualified as silyl ether compounds); and
mixtures thereof.

More specifically, regarding epoxide compounds, it is understood compounds comprising at least one epoxide group, which constitutes the group(s) capable of reacting with the reactive amine and/or hydroxyl groups of the polymer(s) of the polymer component, the epoxide group reacting, in a covalent manner, with a hydroxyl or amine group, in basic or acidic conditions, according to a nucleophilic ring opening mechanism with formation of an ether bond (when the group of the polymer is a hydroxyl group) or of an amine bond (when the group of the polymer is an amine group) between the polymer component and the residue of the epoxide compound.

Regarding anhydride compounds, it is understood compounds comprising at least one anhydride group, which constitutes the group(s) capable of reacting with the reactive amine and/or hydroxyl groups of the polymer(s) of the polymer component, the anhydride group reacting, in a covalent manner, with a hydroxyl or amine group with formation of an ester bond between the polymer component and the residue of the anhydride compound, when the reactive group is a hydroxyl group or with formation of an amide bond between the polymer component and the residue of the anhydride compound, when the reactive group of the polymer is an amine group.

Regarding acyl halide compounds, it is understood compounds comprising at least one acyl halide group (more specifically, at least one acyl chloride group), which constitutes the group(s) capable of reacting with the reactive amine and/or hydroxyl groups of the polymer(s) of the polymer component, the acyl halide group reacting, in a covalent manner, with a hydroxyl or amine group with formation of an ester bond between the polymer component and the residue of the acyl halide compound, when the reactive group of the polymer is a hydroxyl group or with formation of an amide bond between the polymer component and the residue of the acyl halide compound, when the reactive group of the polymer is an amine group.

Regarding silyl ether compounds, it is understood compounds comprising at least one silyl ether group, which constitutes the group(s) capable of reacting with the reactive amine and/or hydroxyl groups of the polymer(s) of the polymer component, the silyl ether group reacting, in a covalent manner, with a hydroxyl group or an amine group with formation of an ether bond between the polymer component and the residue of the silyl ether compound, when the reactive group of the polymer is a hydroxyl group or with formation of an amine silicone bond between the polymer component and the residue of the silyl ether compound, when the reactive group of the polymer is an amine group.

Depending on the functional compound(s) retained, the person skilled in the art will select the operating parameters to make the covalent reaction possible with the hydroxyl groups and/or the amine groups of the polymer component, these operating parameters able to be determined by preliminary tests.

Advantageously, when the polymer intended to be chemically modified, is a polymer comprising, as reactive groups, amine groups, the functional compound(s) are, advantageously, epoxide compounds, which make it possible to form a secondary amine (when the amine groups of the polymer are primary amine groups) or tertiary amine (when the amine groups of the polymer are secondary amine groups) bond with the polymer component to be treated, this type of bond being more stable than an ester or carbamate bond, which is likely to hydrolyse.

More specifically, the functional compound(s) may be epoxide compounds, further comprising an epoxide group, at least one vinyl group, which vinyl group may subsequently react with another organic compound (referred to hereafter as second compound) comprising a group capable of reacting, in a covalent manner, with the vinyl group. By way of example, it may be a glycidyl (meth)acrylate compound, an allyl glycidyl ether compound, a 2-methyl-2-vinyloxirane compound or a 1,2-epoxy-9-decene compound.

By way of example, when the functional compound is glycidyl methacrylate and the polymer is polyamide-12, the covalent reaction step may be schematically represented by the following chemical equation:

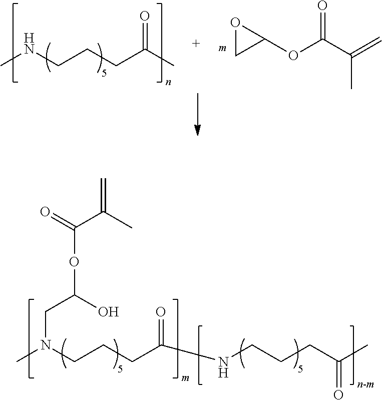

n, m and (n-m) corresponding to the numbers of repetition of repetitive units taken between square brackets and the residue of the glycidyl methacrylate compound thus meeting the formula —CH₂—CH(OH)—O—CO—C(CH₃)═CH₂.

The functional compound(s) may further comprise at least one group capable of conferring to the polymer component a particular targeted property, the targeted properties that may be, in a non-exhaustive manner, hydrophilic, hydrophobic, oleophilic, oleophobic, antibacterial, anti-counterfeit, anti-icing, anti-scratch, flame retardant, electrical load dissipative, cleanability, anti-ageing, aesthetic design (such as colouring, shine), mechanical (such as friction, sliding, impact resistance, abrasion resistance), electrical (such as electrical shielding, electrical conductivity, doping), adhesiveness or non-adhesiveness properties. In this case, the functional compound(s) may thus be qualified as organic compounds of interest.

It is understood by organic compound of interest a compound comprising at least one group capable of conferring or improving a given property to the polymer component.

Furthermore, the reaction step may be carried out in the presence of at least one cosolvent, which may make it possible to improve the solubility of the functional compound(s) and/or to improve the plasticity of the polymer component and thus facilitate the accession of the functional compound(s) to the core of the polymer component.

Furthermore, the reaction step may be carried out in the presence of at least one catalyst.

By way of example, when the functional compound is a compound comprising at least one epoxide group, the cosolvent may be a ketone solvent, such as acetone and the catalyst may be a basic compound, such as a tertiary amine, like triethylamine.

More specifically, the reaction step may include the following operations:
an operation of placing, in a reactor, the polymer component, at least one functional compound, optionally at least one cosolvent and optionally at least one catalyst;
an operation of introducing CO₂ into the reactor;
an operation of pressurising and heating the reactor to a temperature greater than the critical temperature of CO₂ and to a pressure greater than the critical pressure of CO₂, this temperature and this pressure being maintained until completion of the reaction.

As a variant, the operation of pressurising and heating the reactor may be sequenced in the following manner:
an operation of pressurising and heating the reactor to a temperature greater than the critical temperature of CO₂ and to a pressure greater than the critical pressure of CO₂, the temperature and the pressure being selected to generate an impregnation without reaction of the polymer component with the functional compound(s) followed by a possible precipitation of the functional compound(s);
an operation of increasing the pressure and the temperature, the temperature and the pressure being set so as to make possible the covalent reaction of the functional compound(s) with the polymer component, this temperature and this pressure being maintained until completion of said reaction,

this sequence of operations being able to be repeated one or more times.

The placement operation may be performed, advantageously, so that there is no direct contact between the polymer component and the functional compound(s), the possible catalyst and the possible cosolvent.

At the end of the reaction step, the polymer components are thus chemically modified and are bonded in a covalent manner to (or grafted, in a covalent manner, by) residues of the functional compound(s).

It is understood, by residues of the functional compound(s), that functional compound(s) remain after covalent reaction thereof with reactive groups of the polymer component.

After the reaction step, the supercritical conditions are conventionally eliminated, for example, by depressurising the reactor, wherein the reaction took place.

The polymer component thus modified may subsequently be subjected to drying, for example, under vacuum.

The process of the invention may comprise, after or simultaneously with the aforementioned reaction step (preferably, after the aforementioned reaction step), a step of covalent reaction between some or all of the residues of the functional compounds and at least one second compound, which presumes, of course, in this case, that the residues of the functional compound(s) bonded in a covalent manner to the polymer components comprise at least one group able to react in a covalent manner with at least one group of the second compound(s). This covalent reaction step is also carried out in the presence of at least one supercritical fluid, advantageously identical to that used during the reaction step with the functional compound, such as supercritical CO₂. This covalent reaction step involving at least one second compound is, in particular, necessary when the aim of the chemical modification of the process is to obtain or improve a given property of the component and that the aforementioned functional compound(s) having reacted during the reaction step do not comprise group(s) capable of conferring the obtaining or improvement of said property.

By covalent reaction, it is specified that it is a reaction for the formation of covalent bonds, this reaction occurring between the reactive groups of the residues of the functional compound(s) and the reactive groups of the second compound(s).

By way of example, the residue(s) may, comprise, as group(s) capable of reacting with at least one group of the second compound(s), a vinyl group and, in return, the second compound(s) may comprise, as group capable of reacting with a vinyl group of the residue(s), also a vinyl group. In this case, the covalent reaction step may be defined as a step of polymerising the two compound(s) propagating from the aforementioned residues, and more specifically a step of polymerising the second compound(s) comprising a vinyl group, the polymerisation thus propagating from the residues of the functional compound, via the vinyl groups thereof. At the end of this step, there remains thus a polymer component bonded to grafts consisting of polymer chains from the polymerisation of the second compound(s), the bond between the polymer component and the grafts taking place via the residues of the functional compound(s) that form organic spacer groups between the polymer and the grafts, these residues being bonded, on the one hand, in a covalent manner, to the polymer component and, on the other hand, in a covalent manner, to the aforementioned grafts. In this case, the residues are what remains of the functional compound(s) after reaction thereof, on the one hand, with the hydroxyl groups and/or the amine groups of the polymer component and, on the other hand, with the vinyl group(s) of the second compound(s).

More specifically, in this scenario, the process of the invention may be defined as a process for modifying a polymer component comprising at least one polymer comprising, as reactive groups, amine groups and/or hydroxyl groups, said process comprising:
a step of covalent reaction between some or all of said reactive groups and at least one functional compound, also referred to as first compound, comprising at least one group able to react in a covalent manner with said reactive groups, the functional compound(s) being selected from epoxide compounds, anhydride compounds, acyl halide compounds, silyl ether compounds and mixtures thereof, the functional compound(s) further comprising at least one vinyl group, whereby the result is a polymer component bonded, in a covalent manner, to residues of the functional compound(s);
from the vinyl groups of the residues of the functional compound(s), a step of polymerising a second compound comprising at least one vinyl group,

said reaction step and said polymerisation step being carried out in the presence of at least one supercritical fluid.

The second compound(s) may comprise, moreover at least one group capable of conferring or improving a given property to the polymer component, such as a group comprising at least one phosphorus atom, for example, a phosphate group or a phosphonate group to give flame retardant properties to the polymer component, in which case the second compound(s) may be qualified as organic compounds of interest.

More specifically, the second compound(s) may comprise at least one vinyl group and at least one group capable of conferring or improving a given property to the polymer component.

This reaction step may be carried out in the presence of a cosolvent and/or of a catalyst, such as a free radical initiator (such as AIBN).

More specifically, a specific process in accordance with the invention is a process successively comprising:
a step of covalent reaction between some or all of the reactive groups of the polymer(s) of the polymer component and at least one functional compound, also referred to as first compound, comprising at least one group able to react in a covalent manner with said reactive groups, the functional compound(s) being selected from epoxide compounds, anhydride compounds, acyl halide compounds, silyl ether compounds and mixtures thereof, the functional compound(s) further comprising at least one vinyl group, whereby the result is a polymer component bonded, in a covalent manner, to residues of the functional compound;
from vinyl groups of the residues of the functional compound, a step of polymerising a second compound comprising at least one vinyl group,

said reaction step and said polymerisation step being carried out in the presence of at least one supercritical fluid, such as supercritical CO₂

Yet more specifically, a specific process in accordance with the invention is a process successively comprising:
a step of covalent reaction between some or all of the reactive groups of the polymer(s) of the polymer component, which reactive groups are amine groups, with a first compound, which is an epoxide compound comprising at least one vinyl group, for example, glycidyl methacrylate, the epoxide groups reacting, in a covalent manner with some or all of the amine groups, whereby the result is a polymer component bonded, in a covalent manner, to residues of the first compound;
from vinyl groups of the residues of the first compound, a step of polymerising a second compound comprising at least one vinyl group and at least one functional group of interest, such as at least one group comprising at least one phosphorus atom, such as a phosphate group or a phosphonate group,

the covalent reaction step and the polymerisation step being carried out in the presence of at least one supercritical fluid, such as supercritical CO₂.

By way of examples, the second compound may be selected from bis[2-(methacryloyloxy)ethyl]phosphate, diethyl allyl phosphate, diethyl allylphosphonate, dimethyl vinylphosphonate, diethyl vinylphosphonate and mixtures thereof.

More specifically, the step of reacting the polymer component with a second compound may include the following operations:
an operation of placing, in a reactor, the polymer component having reacted with the functional compound(s), at least one second compound, optionally at least one cosolvent and optionally at least one catalyst;
an operation of introducing CO₂ into the reactor, optionally preheated to a temperature above 31° C.;
an operation of pressurising and heating the reactor to a temperature greater than the critical temperature of CO₂ and to a pressure greater than the critical pressure of CO₂, this temperature and this pressure being maintained until completion of the reaction.

As a variant, the operation of pressurising and heating the reactor may be sequenced in the following manner:
an operation of pressurising and heating the reactor to a temperature greater than the critical temperature of CO₂ and to a pressure greater than the critical pressure of CO₂, the temperature and the pressure being selected to generate an impregnation without reaction of the polymer component with the second compound(s) followed by a possible precipitation of the second compound(s);
an operation of increasing the pressure and the temperature, the temperature and the pressure being set so as to make possible the covalent reaction of the second compound(s) with the residues of the functional compound(s) bonded in a covalent manner to the polymer component, this temperature and this pressure being maintained until completion of said reaction,

this sequence of operations being able to be repeated one or more times.

This operating mode may make it possible to obtain a modification of the polymer component in its entirety without concentration gradient.

The placement operation may be performed, advantageously, so that there is no direct contact between the polymer component and the compound(s), the possible catalyst and the possible cosolvent.

After the reaction step involving at least one second compound, the process comprises, advantageously, a step of stopping the supercritical conditions and optionally a step of drying the modified polymer component.

Whatever the embodiments, the modification process may be considered, in particular, as a process capable of conferring or improving a given property of the polymer component, for example, a process capable of conferring flame retardant properties to the polymer component.

The process of the invention may be implemented in a device, for example, of the autoclave type, comprising an enclosure intended to receive the polymer component, the reagents, the supercritical fluid, the possible cosolvent and the possible catalyst, means for regulating the pressure of said enclosure to place it in a vacuum (for example, via a vacuum pump communicating with the enclosure) and heating means.

Other advantages and features of the invention will become apparent in the following non-limiting detailed description.

### BRIEF DESCRIPTION OF THE DRAWINGS

FIG. 1 is a ¹H NMR spectrum of a polyamide sample treated with glycidyl methacrylate according to Example 1.

FIG. 2 is a ¹H NMR spectrum of glycidyl methacrylate.

FIG. 3 is a ¹H NMR spectrum of an untreated polyamide sample as disclosed in Example 1.

FIG. 4 is a superposition of areas of the spectrum of FIG. 1 and FIG. 3.

FIG. 5 is an IR spectrum of a polyamide sample treated with glycidyl methacrylate (curve a) and of a polyamide sample treated with glycidyl methacrylate then diethyl allyl phosphate (curve b) according to Example 1.

### DETAILED DESCRIPTION OF PREFERRED EMBODIMENTS

### Example 1

This example illustrates the implementation of a specific mode of the chemical modification process of the invention, which comprises, in a first time, a chemical modification of a polyamide-12 component with glycidyl methacrylate (named below GMA), this modification being carried out under supercritical CO₂ in a specific reactor.

The simplified reaction diagram of this modification reaction may be the following:

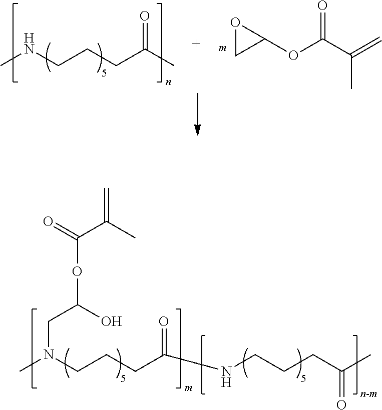

n, m and (n-m) corresponding to the numbers of repetition of repetitive units taken between square brackets.

The aforementioned specific reactor is a stainless steel reactor of the batch type of 600 mL equipped with an external heating system. CO₂ is introduced into the reactor with a double piston pump the heads of which are cooled to a temperature less than 5° C. to have CO₂ in liquid phase and avoid cavitation problems during the injection into the reactor. The reactor is preheated to a temperature above 31° C., in order to avoid the presence of liquid CO₂ in the reactor. The reactor is equipped, in its bottom, with a crystalliser of 60 mL capacity intended to receive the functional compound, the catalyst and the cosolvent. The polyamide-12 component is suspended in the reactor above the reagent to avoid any contact with the crystalliser.

More specifically, the polyamide-12 component is a polyamide-12 tensile specimen of dimensions 61*9*3.7 mm for the widest portion of the specimen and 61*3*3.7 mm for the thinnest portion of the specimen.

In the crystalliser of the aforementioned reactor are deposited 10 mL of glycidyl methacrylate (referred to hereafter as GMA), 2 mL of triethylamine and 20 mL acetone. The aforementioned specimen is placed above the crystalliser and is not in contact with the liquids contained. The role of the acetone added in the crystalliser is to dilute the glycidyl methacrylate, in order to avoid its self-polymerisation during reaction and has not specifically been re-added to improve the penetration of the compound into the polyamide or the solubility of the glycidyl methacrylate in the supercritical CO₂.

Once the reactor has been reclosed and sealed, CO₂ is added via a pump in the reactor until 50 bar is reached at ambient temperature. The reactor is subsequently heated to 50° C. and the pressure is adjusted to 100 bar. The heating set point is subsequently set at 140° C. The reactor changes from 50° C. to 140° C. and from 100 bar to 300 bar in 1 h. After 6 hours of treatment at 140° C. and 300 bar, the reactor is depressurised from 300 to 70 bar in 10 minutes and from 70 bar to atmospheric pressure in 5 minutes, the depressurisation being performed via various valves placed on the cover of the reactor.

The reactor is subsequently opened and the specimen that has become brown is recovered then dried in the oven under vacuum at 105° C. overnight, its mass after drying being stable. The mass of the specimen has changed from 1.16 g before treatment to 1.23 g after treatment and drying. The gain of mass is therefore 6%.

The colouring caused by the modification by GMA is observed even at the core of the specimen treated in accordance with the process of the invention. It is also observed an intensity gradient of the colouring of the exterior at the core of the specimen as well as disparities within the actual component. These disparities correspond to stripes observed on the untreated specimen and caused by the method for manufacturing polymer components.

In order to ensure effective chemical modification of the specimen, this was characterised by ¹H NMR.

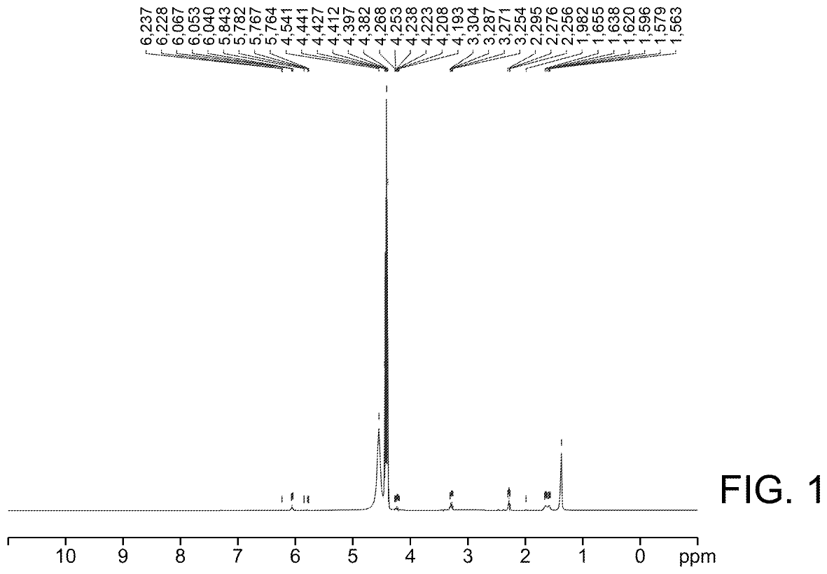

For this, 20 mg of polymer, taken in the thinnest portion of the specimen, are dissolved in a mixture 8:2 by volume of hexafluoroisopropanol and of deuterated chloroform. The ¹H NMR spectrum is acquired on a 400 Mhz Bruker Avance II spectrometer with 128 scans at 298 K for the polyamides thus dissolved, this spectrum being illustrated in FIG. 1. It should be noted that, during the dissolution of the treated polyamide sample, the extreme surface of the piece of the component was not dissolved by the solvent, and this probably due to a high level of chemical modification at the surface of components having significantly reduced the solubility of the polymer in the solvent.

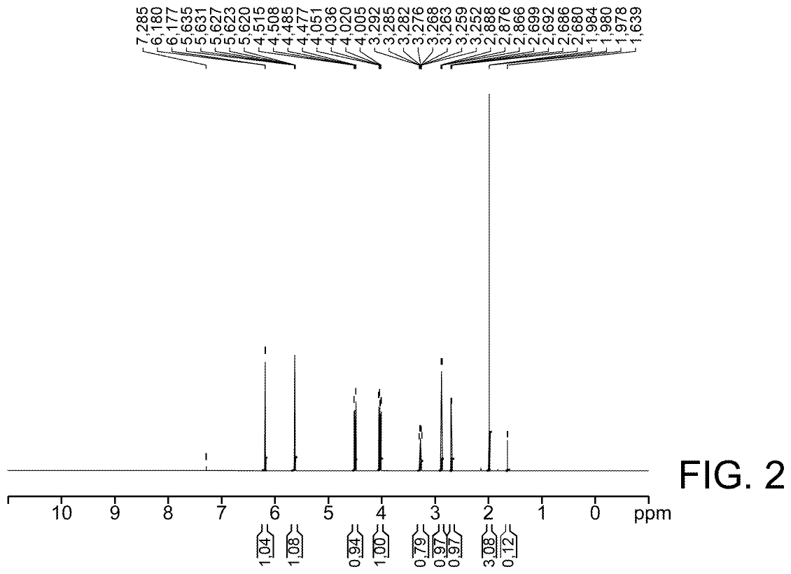

By way of comparison, the GMA is analysed in pure CDCl₃ with a concentration of 1% by volume and by using the same analysis parameters as in the case of the polyamides, the ¹H NMR spectrum being illustrated in FIG. 2.

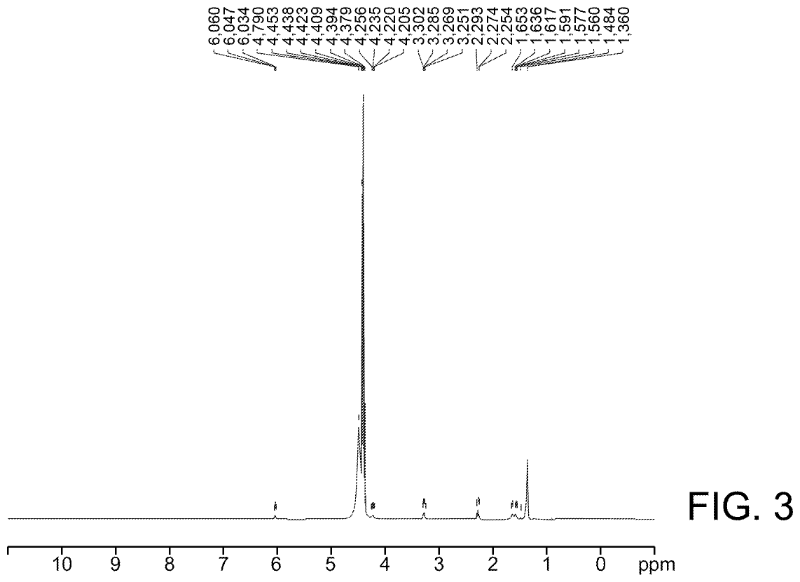

By way of comparison, an untreated piece of specimen was analysed by using the same analysis parameters as in the case of the treated component, the ¹H NMR spectrum being illustrated in FIG. 3.

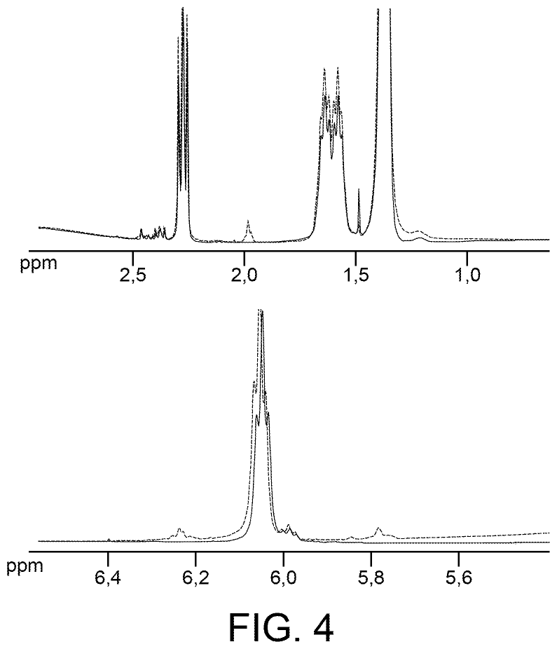

Zooms of a superposition of the spectrum of the treated component and of the untreated component are illustrated in FIG. 4.

On this superposition, it is observed 3 new peaks on the spectrum of the treated component: a peak at 1.98 ppm corresponding to the methyl group present on the GMA, a peak centred at 5.78 ppm and a peak at 6.23 ppm both corresponding to vinyl protons present on the GMA. The residue of the protons of the GMA is not observed on these spectra due to their probable superposition with the signals from the polyamide-12, much more intense, making their detection difficult. To quantitatively measure the grafting of the GMA in the polymer, the signals of the methyl group of the GMA and of methylene groups of the polyamide (peak at 2.28 ppm) are integrated and the global grafting degree (in %) is determined by the formula below:

$$Global grafting degree ( \% ) = \frac{2 \times {I}_{CH 3 GMA}}{3 \times {I}_{CH 2 PA 12}}$$

I_{CH3GMA} being integral with the peak at 1.98 ppm corresponding to the methyl of the GMA and I_{CH2PA12} being integral with the peak at 2.28 ppm corresponding to a methylene group of the polyamide-12.

The calculation makes it possible to estimate the grafting degree at 3.8% molar. This measured grafting degree makes it possible to validate the grafting of GMA to polyamide-12 under supercritical CO₂ in the conditions studied but does not make it possible to measure the modification gradient within specimens. It is furthermore probably underestimated due to the non-solubilisation of the surface of the specimen that is the portion the most likely to be modified.

This example makes it possible to show that a treatment under supercritical CO₂ with glycidyl methacrylate makes modification at the core of polyamide-12 specimens possible.

The polyamide-12 component thus modified by GMA is, in a second time, modified again by making the vinyl groups of the residues of GMA react with a compound also including a vinyl group, in this case, diethyl allyl phosphate (DEAP), the simplified reaction diagram of this new modification that may be the following:

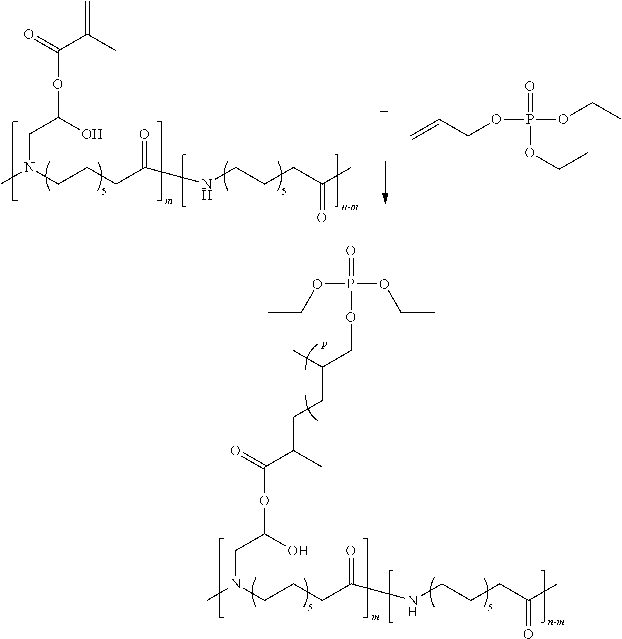

m, (n-m) and p corresponding to the numbers of repetition of repetitive units taken between square brackets.

The treatment is carried out in the reactor such as defined for the first 5 step.

The following reagents are deposited in a crystalliser at the bottom of the reactor:
2.5 mL of DEAP;
0.2 g of azobisisobutyronitrile;
10 mL of acetone.

The PA-12 specimen is placed in such a way as to not be in contact with the liquids at the bottom of the reactor.

Once the reactor has been reclosed and sealed, CO₂ is added via a pump in the reactor until 50 bar is reached at ambient temperature. The reactor is subsequently heated to 40° C. and the pressure is adjusted to 100 bar. After four hours of impregnation, the heating set point is set at 80° C. The reactor changes from 43° C. to 76° C. and from 100 bar to 270 bar in 1 hour (with pressure adjustment to reach the final pressure). After 3 hours of treatment at 80° C. and 2,700 bar, the reactor is depressurised from 2,700 to 70 bar in 10 minutes and from 70 bar to atmospheric pressure in 5 minutes.

The reactor is subsequently opened and the specimen is recovered then dried in the oven under vacuum at 105° C. overnight, its mass after drying being stable.

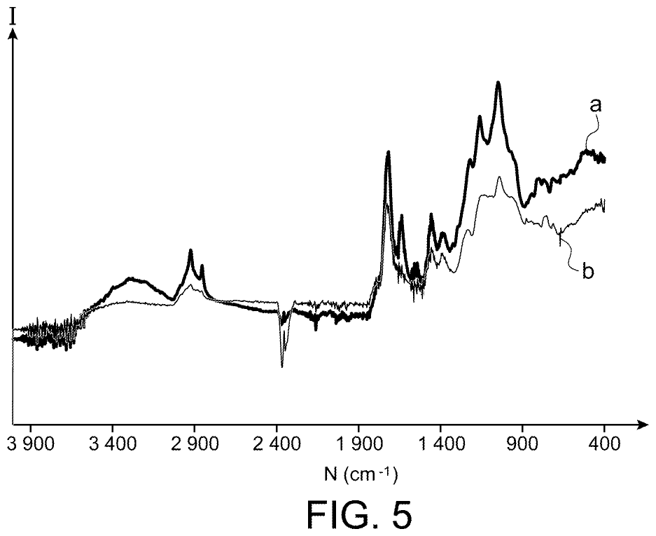

The specimen is subsequently infrared analysed in ATR mode. The spectra of the surface of the specimen before (curve a)) and after modification by DEAP (curve b)) are provided in FIG. 5 appended, the ordinate corresponding to the intensity I and the abscissa to the number of waves N (in cm⁻¹).

On this spectrum, a significant reduction of peaks at 1,640 and 1,550 cm⁻¹, corresponding to the C═O bonds of amides and to the C—N bonds of amides respectively is observed. Furthermore, an enlargement and an increase of the intensity of the peaks at 1,120 and 951 cm⁻¹ is observed, corresponding to the presence of P═O and P—OC bonds. In infrared, it is difficult to distinguish the formation of a C—C bond (case of the present reaction) due to its omnipresence in most organic compounds. The presence of signals corresponding to the presence of phosphorus compound therefore indicates the presence of DEAP. As its boiling point is towards 45° C. and the specimen has been dried under vacuum at 105° C. overnight, the presence of non-grafted DEAP would have been eliminated. The modification of vibrations of amide bonds may for their part be due to the presence of the acid phosphate group, which, by modification of the H bonds formed between the amides of the polymer, could have impacted the vibrations of the surrounding bonds such as the C—N and the C═O of amides.

The analysis therefore confirms the possibility of grafting in two steps a functional compound, in this case an organophosphorus compound for its flame retardant properties, a priori not graftable, directly on PA-12 by supercritical CO₂ route.

What is claimed is:

1.-16. (canceled)

17. Chemical modification process for a polymer component comprising at least one polymer comprising, as reactive groups, amine groups and/or hydroxyl groups, said process comprising a step of covalent reaction between some or all of the reactive groups and at least one functional compound comprising at least one group able to react in a covalent manner with said reactive groups, the functional compound(s) being selected from epoxide compounds, anhydride compounds, acyl halide compounds, silyl ether compounds and mixtures thereof, wherein the covalent reaction step is carried out in the presence of at least one supercritical fluid.

18. Process according to claim 17, wherein the supercritical fluid is supercritical CO₂.

19. Process according to claim 17, wherein the polymer component is a component comprising one or more polyamides.

20. Process according to claim 17, wherein the polymer component is a polyamide-12 component.

21. Process according to claim 17, wherein the functional compound(s) are non-polymer compounds.

22. Process according to claim 17, wherein the functional compound(s) are epoxide compounds.

23. Process according to claim 17, wherein the functional compound(s) are epoxide compounds comprising at least one vinyl group.

24. Process according to claim 17, wherein the functional compound(s) further comprise at least one group capable of conferring to the polymer component a given property or improving a given property of the polymer component.

25. Process according to claim 17, wherein the reaction step is carried out in the presence of at least one cosolvent.

26. Process according to claim 17, wherein the reaction step includes the following operations:
an operation of placing, in a reactor, the polymer component, at least one functional compound, optionally at least one cosolvent and optionally at least one catalyst;
an operation of introducing CO₂ into the reactor;
an operation of pressurising and heating the reactor to a temperature greater than the critical temperature of CO₂ and to a pressure greater than the critical pressure of CO₂, this temperature and this pressure being maintained until completion of the reaction.

27. Process according to claim 17, comprising, after or simultaneously with the reaction step such as defined in claim 17, another step of covalent reaction between some or all of the residues of the functional compounds and at least one second compound, this step being carried out in the presence of at least one supercritical fluid.

28. Process according to claim 27, wherein the residue(s) comprise, as group(s) capable of reacting with at least one group of the second compound, a vinyl group.

29. Process according to claim 27, wherein the second compound comprises at least one vinyl group and at least one group capable of conferring or improving a given property to the polymer component.

30. Process according to claim 28, successively comprising:
a step of covalent reaction between some or all of the reactive groups of the polymer(s) of the polymer component and at least one functional compound comprising at least one group able to react in a covalent manner with said reactive groups, the functional compound(s) being selected from epoxide compounds, anhydride compounds, acyl halide compounds, silyl ether compounds and mixtures thereof, the functional compound(s) further comprising at least one vinyl group, whereby the result is a polymer component bonded, in a covalent manner, to residues of the functional compound;
from vinyl groups of the residues of the functional compound, a step of polymerising a second compound comprising at least one vinyl group,
said reaction step and said polymerisation step being carried out in the presence of at least one supercritical fluid.

31. Process according to claim 30, wherein:
the reactive groups are amine groups;
the first compound is an epoxide compound comprising at least one vinyl group;
the second compound comprises at least one vinyl group and at least one group comprising at least one phosphorus atom.

32. Process according to claim 17, which is a process capable of conferring or improving a given property of the polymer component.
